(19) United States
(12) Patent Application Publication
(10) Pub. No.: US 2023/0364526 A1
(43) Pub. Date: Nov. 16, 2023

(54) A SYSTEM AND METHOD FOR EVAPORATION AND CONDENSATION

(71) Applicant: ROCHEM SEPARATION SYSTEM INDIA (P) LTD., Maharashtra (IN)

(72) Inventor: Prayas GOEL, Maharashtra (IN)

(21) Appl. No.: 18/030,899

(22) PCT Filed: Oct. 8, 2021
(86) PCT No.: PCT/IN2021/050968

§ 371 Date: Apr. 7, 2023

(30) Foreign Application Priority Data
Oct. 8, 2020 (IN) 202021043781

(51) Int. Cl. B01D 1/26; B01D 3/06; B01D 5/00; C02F 1/04; C02F 1/06

(52) U.S. Cl. CPC B01D 1/26; B01D 3/06; B01D 5/006; C02F 1/043; C02F 1/06

(57) ABSTRACT

The present invention relates to a system and method for evaporation and condensation with particular but not exclusive application in distillation of water, waste water treatment and desalination process. The system comprises of plurality of evaporation frame (4), condensation frame (3) and preheat frame (6). Plurality of frames may be combined to form a stack. Plurality of stacks together form a unit, plurality of such units may be combined to form a multistage evaporation and condensation system.

### FIELD OF THE INVENTION

The present invention generally relates to the field of treatment and purification of liquid and more particularly relates to a system and method for evaporation and condensation with particular but not exclusive application in distillation of water, waste water treatment and desalination process.

### BACKGROUND OF THE INVENTION

Evaporators and condensers units called stage and multiple of it called multi stage are mostly build out of steel, up to high grade steel or even titanium. In wastewater treatment, especially the pH value of the wastewater further called solution is far away from neutral. To protect the steel of high (Acidic) or low ph values the solution will be neutralized what creates a negative effect, the salt load is increasing. Evaporation is energy intense and condensation needs a lot of cooling power therefore, it is desirable to provide an Evaporator-Condenser Stage which can withstand difficult to treat solutions and can be designed as a multi-stage system to reduce energy consumption.

In view of the above there is a need for an energy efficient evaporation-condensation unit comprising of modules which are resistant to fouling and which also conducts heat transfer effectively.

### SUMMARY OF THE INVENTION

This summary is provided to introduce a selection of concepts in a simplified format that are further described in the detailed description of the invention. This summary is not intended to identify key or essential inventive concepts of the claimed subject matter, nor is it intended for determining the scope of the claimed subject matter.

An embodiment of the present invention discloses a system for evaporation and condensation comprising at least one evaporation-condensation unit comprising a plurality of frames arranged in a series of stacks, wherein each stack comprises of at least one evaporation frame (4), at least one preheating frame (6) and at least one condensation frame (3). Said frames are separated from each other using a polymeric sheet (8). Each of said frames comprises a top support, a functional area, and a plurality of channels and orifices for enabling the flow of fluid in multiple forms. The frames are made of a polymeric material and these frames are detachably integrated within the evaporation-condensation unit (2), the plurality of frames are alternatively arranged within the evaporation-condensation unit.

Another embodiment of the present invention discloses a system for evaporation and condensation comprising at least one evaporation-condensation unit comprising a plurality of frames arranged in a series of stacks. Each of said stack comprises at least one evaporation frame (4) configured with a bottom flash chamber (41) with an orifice (19) opening into a functional area (56), two closed feed channels (29, 30) on either side of the bottom flash chamber (41), two top vapour channels (15, 16) with respective orifices (17, 18) opening in to the functional area (56). The stack further comprises of at least one preheating frame (6) comprising two feed channels (29, 30) with orifices (31, 32) opening into a functional pre-heating chamber (33) on either side of a bottom closed feed channel (42), a top feed channel (34) with an orifice (35) opening into the functional pre-heating chamber (33). The stack also comprises of at least one condensation frame (3) comprising a bottom closed feed channel (42) with two closed feed channels (29, 30) on either side, two top vapour channels (19, 20) with respective orifices (21, 22) opening into a functional condensation area (23), two distillate channels (26, 27) with orifices (24, 25) on either side of the bottom closed feed channels (29, 30) opening into the functional condensation area (23). A polymeric sheet (8) separating the evaporation frame (4), condensation frame (3) and the pre-heating frame (6) from each other.

Yet another embodiment of the present invention discloses a method for evaporation and condensation, the method comprising passing a feed (10) through at least one evaporation-condensation unit (2) at a first inlet A, wherein the at least one evaporation-condensation unit comprises a plurality of frames arranged in a series of stacks, each stack comprises at least one evaporation frame (4), at least one preheating frame (6) and at least one condensation frame (3); and a polymeric sheet (8) separating each frame from other; distributing the feed to the at least one preheating frame (6) of the at least one evaporation-condensation unit (2); preheating the feed (10) in the at least one preheating frame (6) and passing the preheated feed to at least one heat exchanger coupled with the at least one evaporation-condensation unit at a first outlet B; heating the feed further to a higher temperature in the at least one heat exchanger (12) to form a further heated feed (11); feeding back the further heated feed (11) to the at least one evaporation-condensation unit (2) at a second inlet E, flashing the further heated feed (11) in the at least one evaporation frame (4) to a lower temperature according to the thermodynamic conditions to form a vapour (7); passing the vapor (7) to at least one condensation frame (3) separated by the polymer sheet (6) from the least one evaporation frame (6) and the least one preheating frame (4); forming a distillate (5) and a concentrate (13) by condensing the vapour (7) at the at least one condensation frame (3) and collecting the distillate (5) from the evaporation-condensation unit (2) at a distillate outlet (H) and the concentrate (13) from the evaporation-condensation unit (2) at a concentrate outlet (G); wherein each frame is made of a polymer material and the plurality of frames are detachably integrated within the evaporation-condensation unit (2), the plurality of frames are alternatively arranged within the evaporation-condensation unit.

### OBJECT OF THE INVENTION

The object of the present invention is to provide system for evaporation and condensation.

Another object of the present invention is to provide a method for evaporation and condensation.

### BRIEF DESCRIPTION OF THE DRAWINGS

The detailed description is described with reference to the accompanying figures. Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates flow of the feed through different frames.

FIG. 2 illustrates evaporation and condensation system with additional feed preheat frames.

FIG. 3 illustrates evaporation and condensation system with additional evaporation frames.

FIG. 4 illustrates two stages of evaporation and condensation system.

FIG. 5 illustrates a compact version of a two-stage evaporation and condensation system.

FIG. 6 illustrates an evaporation condensation system with a flash evaporation chamber at the bottom.

FIG. 7 illustrates a two stage evaporation condensation system with the different type of evaporation chamber of FIG. 6.

FIG. 8 illustrates a functional frame unit.

FIG. 9 illustrates flow of vapour through evaporation frame and condensation frame.

FIG. 10 illustrates flow of feed to pre-heat frames through evaporation and condensation frame.

FIG. 11 illustrates flow of further heated feed through preheat frame, condensation frame and evaporation frame.

It should be appreciated by those skilled in the art that any diagrams herein represent conceptual views of illustrative systems embodying the principles of the present invention.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” or “in an exemplary embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method.

The present invention relates to a system and method for evaporation and condensation. The application of the present system and method can be found particularly but not exclusively in water purification, distillation of water, waste water treatment and desalination.

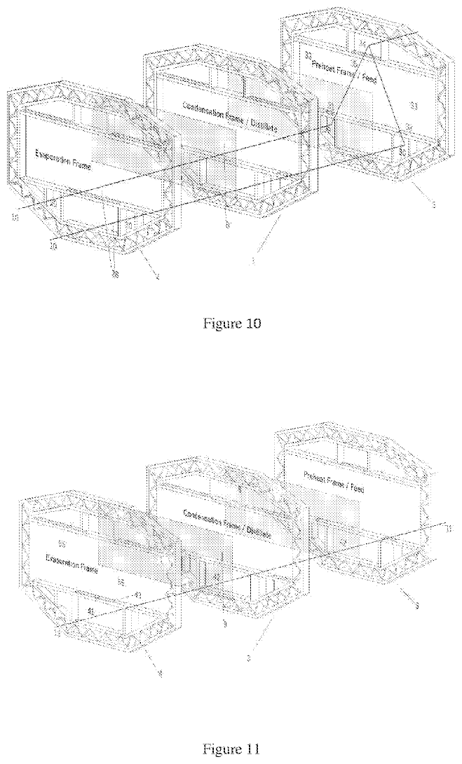

In an exemplary embodiment of the present disclosure, a modular frame as disclosed in the Indian Patent Application No. 202021043600 and the like, is used and incorporated in its entirety herewith. The system comprises of plurality of polymeric frames namely evaporation frames (4), condensation frames (3) and pre-heat frames (6). The frames are enclosed in a pressure tight sealed unit. FIG. 9 illustrates the functional aspect of a frame. Each frame is configured to embody multiple fluid flow channels, openings and orifices. Each frame further comprises, a functional area (for evaporation or condensation or pre-heating). These frames are separated by a condensing polymeric sheet (8) which essentially covers functional area of each frame. These frames can be arranged in plurality of combinations. Combination of frames forms a stack, plurality of such stacks may be combined to form a single evaporation and condensation unit. Plurality of evaporation and condensation unit can be combined to form a multistage evaporation and condensation system. Below table illustrates different configurations of a stack which can be combined in series:

| Sr | | | Reference |
|---|---|---|---|
| No. | Description | Stack Configuration* | FIG. No. |
| 1. | Stack | [(3, 6, 3, 4) + (3, 6, 3, 4) . . .] | FIG. No. 1 |
| | Combination 1 | | |
| 2. | Stack | [(3, 6, 3, 4, 3, 6, 3, 6) + (3, 6, 3, | FIG. No. 2 |
| | Combination 2 | 4, 3, 6, 3, 6) . . .] | |
| 3. | Stack | [(3, 6, 3, 4, 4) + (3, 6, 3, 4, | FIG. No. 3 |
| | Combination 3 | 4) . . .] | |

*Numbers in stack configuration indicates respective frames (3-condensation frame, 4-Evaporation frame, 6-Preheat frame)

Different stack combination may be combined to form a unit and plurality of such units may be combined to form a multi-stage Evaporation and condensation system.

An exemplary embodiment of the present invention discloses a system for evaporation and condensation comprising at least one evaporation-condensation unit comprising a plurality of frames arranged in a series of stacks, wherein each stack comprises of at least one evaporation frame (4), at least one preheating frame (6) and at least one condensation frame (3). Said frames are separated from each other using a polymeric sheet (8). Each of said frames comprises a top support, a functional area, and a plurality of channels and orifices for enabling the flow of fluid in multiple forms. The frames are made of a polymeric material and these frames are detachably integrated within the evaporation-condensation unit (2), the plurality of frames are alternatively arranged within the evaporation-condensation unit.

A system for evaporation and condensation comprising at least one evaporation-condensation unit comprising a plurality of frames arranged in a series of stacks. Each of said stack comprises at least one evaporation frame (4) configured with a bottom flash chamber (41) with an orifice (19) opening into a functional area (56), two closed feed channels (29, 30) on either side of the bottom flash chamber (41), two top vapour channels (15, 16) with respective orifices (17, 18) opening in to the functional area (56). The stack further comprises of at least one preheating frame (6) comprising two feed channels (29, 30) with orifices (31, 32) opening into a functional pre-heating chamber (33) on either side of a bottom closed feed channel (42), a top feed channel (34) with an orifice (35) opening into the functional pre-heating chamber (33). The stack also comprises of at least one condensation frame (3) comprising a bottom closed feed channel (42) with two closed feed channels (29, 30) on either side, two top vapour channels (19, 20) with respective orifices (21, 22) opening into a functional condensation area (23), two distillate channels (26, 27) with orifices (24, 25) on either side of the bottom closed feed channels (29, 30) opening into the functional condensation area (23). A polymeric sheet (8) separates the evaporation frame (4), condensation frame (3) and the pre-heating frame (6) from each other.

Yet another embodiment of the present invention discloses a method for evaporation and condensation, the method comprises the steps of passing a feed (10) through at least one evaporation-condensation unit (2) through a first inlet A, wherein the at least one evaporation-condensation unit comprises a plurality of frames arranged in a series of stacks, each stack comprises at least one evaporation frame (4), at least one preheating frame (6) and at least one condensation frame (3) and a polymeric sheet (8) separating each frame from other; distributing the feed to the at least one preheating frame (6) of the at least one evaporation-condensation unit (2); preheating the feed (10) in the at least one preheating frame (6) and passing the preheated feed to at least one heat exchanger coupled with the at least one evaporation-condensation unit at a first outlet B; heating the feed further to a higher temperature in the at least one heat exchanger (12) to form a further heated feed (11); feeding back the further heated feed (11) to the at least one evaporation-condensation unit (2) at a second inlet E, flashing the further heated feed (11) in the at least one evaporation frame (4) to a lower temperature and temperature according to the thermodynamic conditions to form a vapour (7); passing the vapour (7) to at least one condensation frame (3) separated by the polymer sheet (6) from the least one evaporation frame (6) and the least one preheating frame (4); forming a distillate (5) and a concentrate (13) by condensing the vapour (7) at the at least one condensation frame (3) and collecting the distillate (5) from the evaporation-condensation unit (2) at a distillate outlet (H) and the concentrate (13) from the evaporation-condensation unit (2) at a concentrate outlet (G); wherein each frame is made of a polymer material and the plurality of frames are detachably integrated within the evaporation-condensation unit (2), the plurality of frames are alternatively arranged within the evaporation-condensation unit. The method is performed at a pressure level ranging from a positive pressure to a negative pressure and at a temperature ranging from above 100° C. to temperatures far below 100° C for the process of evaporation and condensation. In present embodiment of the disclosure, the working temperature of the method ranges from 5° C. to 160° C. and the working pressure ranges from 8 mbara to 6.2 bara. The pressure levels indicated here in bara are absolute pressures in bar. In a preferred embodiment of the present disclosure, the working temperature of the method ranges from 40° C. to 130° C. and the working pressure ranges from 73.75 mbara to 2.70 bara.

FIG. 1 illustrates the flow of the liquid feed (10) through plurality of frames. Feed (10) enters the evaporation and condensation stage 1 at A. The feed (10) is distributed to at least one preheat frame (6). The preheated feed (10) leaves the evaporation and condensation stage 1 at B. The preheated feed (10) enters the heat exchanger (12) at D and leaves the heat exchanger (12) at a higher temperature at F. The further heated feed (11) enters evaporation and condensation stage 1 at E. The further heated feed (11) enters at least one flash/evaporation frame (4), where the further heated feed (11) flashes to a lower temperature and pressure according the thermodynamic conditions in the evaporation and condensation stage (1). The vapour (7) is in the vapour chamber (2). By flashing, the feed (11) is concentrated and becomes the concentrate (13).

The concentrate (13) leaves the evaporation and condensation stage 1 at the position G. The vapour (7) produced by the flashing of the further heated feed (11) flows to the condensation frames (3). The vapour (7) condenses on the outer surface of the sheet/film for condensation (8), of at least one preheat frame (6), and heats up the feed (10). The preheat frames (6), the condensation frames (3) and the frames for evaporation frames (6) are separated from each other by a vapor and liquid tight polymer sheet (8). Preference is to use a polymer film, for example Polypropylene (PP), Polyvinylidene fluoride (PVDF), Polyvinyl Chloride (PVC) or other polymers for the sheet for condensation (8). For a good heat transfer a thin film is preferred in the range of 10 μm to 40 μm. The condensed vapour (7) forms a distillate (5). The condensate (5) leaves the evaporation and condensation stage (1) at G. The evaporation and condensation stage (1) operates free of non-condensable gases (NCG). The feed (10) brings dissolved gases NCG into the system. By heating up the solution the non-condensable gases are released, the non-condensable gases flows with the vapour into the top vapour chamber (15, 16) and then to the condensation frame 4. From there the vapour flows with the condensate/distillate (5) to the opening H or are streaming with the condensate/distillate (5) into the next stage as illustrated in FIG. 4.

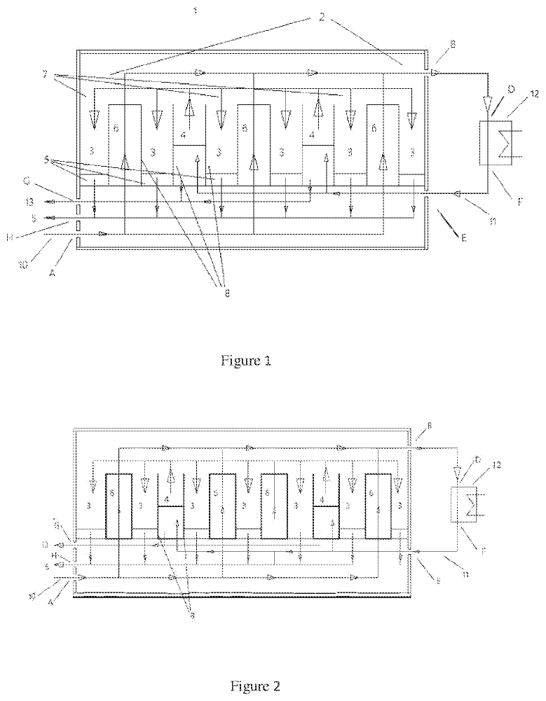

In FIG. 2 an additional feed preheat frame (6) is added. With increase in number of feed-preheat frames (6) the energy by evaporation in the flash/evaporation frames (4) can be balanced with the energy becoming free by condensation on the sheet (8) on the outside of the feed preheat frame (6) and heat transfer through the sheet (8) to the feed (10).

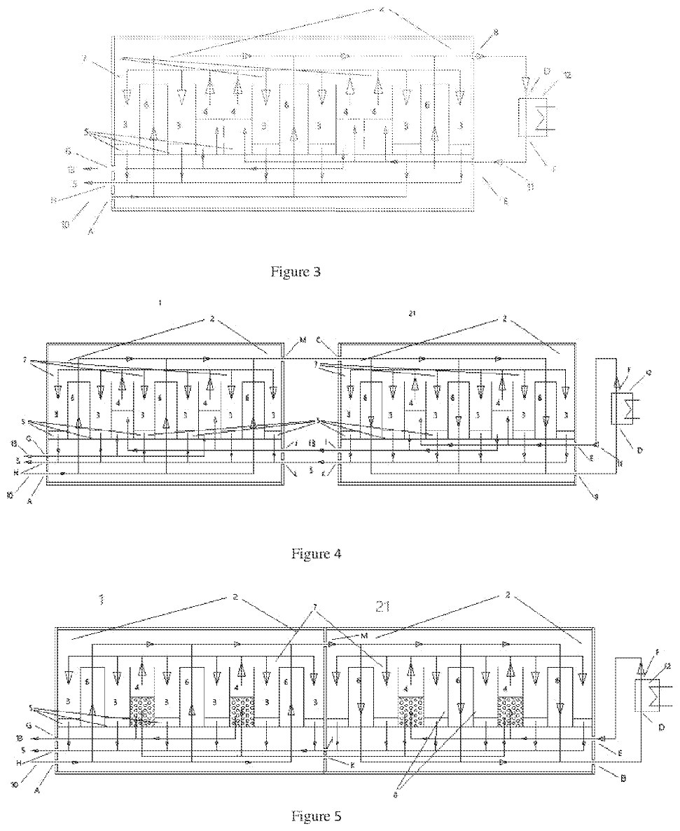

As shown in FIG. 3 addition of evaporation frame (4) allows more volume for evaporation. Condensation frames (3), evaporation frame (4) and preheat frames (6) can be combined in numbers as needed according to the thermodynamic requirements. Also, the total number of frames and the combination of frames in a stage may vary.

FIG. 4 shows an evaporation and condensation system with two stages (1) and (1a). Each stage has a vapour chamber (2). The preheated feed out of stage (1) at M enters stage (1a) at C, passes the pre-heat frames (6) of stage (1) and leaves stage (1a) at I. The preheated feed (10) leaves the evaporation and condensation stage (1a) at E. The preheated feed (10) enters the heat exchanger (12) at D and leaves the heat exchanger (12) at a higher temperature at (F). The further heated feed (11) enters evaporation and condensation stage (1a) at E. The further heated feed (11) is entering at least one evaporation frame (4), where the feed (11) flashes to a lower temperature and pressure according to the thermodynamic conditions in the evaporation and condensation chamber (la). The concentrate/brine (13) leaves stage (1a) at I and enters stage 1 at J.

FIG. 5 illustrates a compact version of the two-stage system. The condensate (5) out of stage (1a), when entering stage (1) at I is flashing to a lower temperature and pressure according the thermodynamic conditions in the evaporation and condensation stage (1). This vapour (7) is condensed on the outside of the film for condensation (8) of the preheat frames (6). So, the energy from evaporation is released by condensation on the film for condensation (8) of the preheat frames (6) and heats up the feed (10).

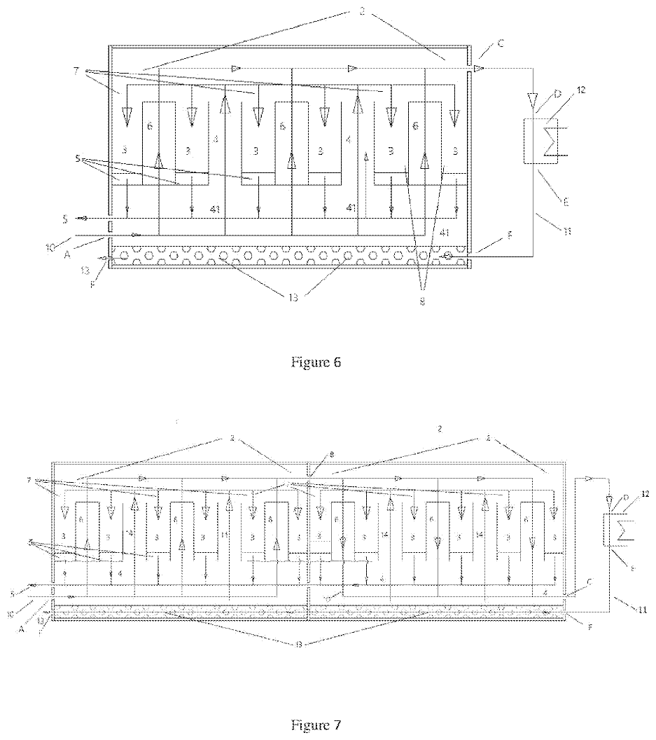

FIG. 6 shows an evaporation condensation system with a different type of evaporation/flash chamber (41). It is a unique flash chamber below the condensation frame (3), the evaporation frame (4) and the preheat frame (6). The evaporation chamber (411) is connected via evaporation frame (4) with the vapour chamber (2). The vapour (7) produced by evaporation passes through evaporation frame (4) and enters the condensation frame (3) from the top where it condenses on the outside of the sheet (8) of the preheat frame (6) where it forms the distillate/condensate (5).

FIG. 7 illustrates a two stage evaporation condensation system with the different type of evaporation chamber (411) of FIG. 6.

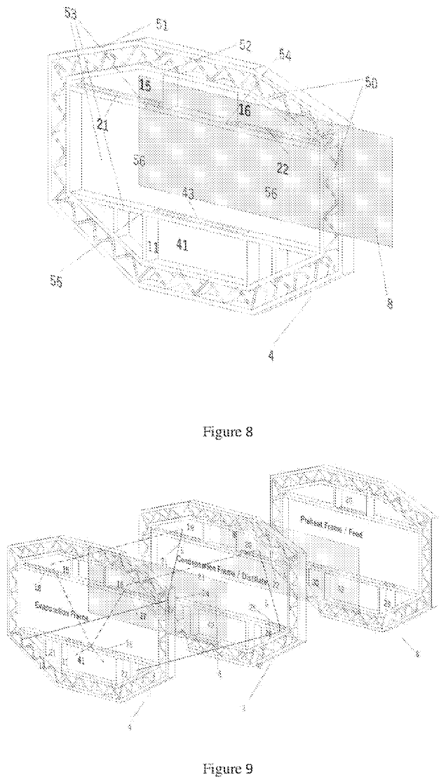

FIG. 8 illustrates the functional frame unit of the evaporation and condensation system. The outer framework (50) separated to the outside, for example the ambient environment, by a closed ring (51) and separated to the inside (53) by an inner closed ring (52). The inside (53), inside means all structure within the ring (52). In the inside (53) there are functional areas (54, 55) for the process streams solution and vapour. Between the functional areas (54, 55) and the left and right wall of the ring (52) is the active area (56) for vapour transfer. The active area (56) is covered on both sides by the film/sheet for condensation (8).

FIG. 9 illustrates flow of feed through individual evaporation condensation and pre-heat frame. As illustrated in FIG. 10 The Feed/concentrate (10) flashes in the bottom flash chamber (41) of the evaporation frame (4). In the evaporation frame (4) the vapour (7) exits through the orifice 19 and flows from between the two polymeric sheets (8) separating the frames, to the top vapour channels (15 and 16) passing through the top orifices (17 and 18). The vapour further enters the condensing frame (3) in the vapour channels (19 and 20). The vapour enters the Functional condensation area (23) via the top orifices (21 and 22) and condenses on the surfaces of the sheets for condensation (8) forming the condensate/distillate (5) (as illustrated by a continuous line in FIG. 10). The distillate flows via the orifices (25, 24) into the distillate channel (26, 27).

FIG. 10 shows the standard configuration of an evaporator/condenser stage (1) comprising of frame (4), (3) and (6). The continuous line (28) shows the flow path of the feed (10). The feed (10) passes through the bottom closed channels (29 and 30) of the condensation frame (3) and evaporation frame (4), and flows into the preheating frame (6) in the position of the feed channels (29 and 30). The feed enters the functional pre-heat area (33) by passing through the orifices (31, 32). The feed passes the functional pre-heat area (33) between two sheets for condensation (8) into the top feed channel (34) by passing the feed through top orifice (35). This is the upstream configuration. Alternatively, the feed (10) can also flow in the opposite direction downstream entering by the feed channel (34), frame (6) and flowing downstream in the functional pre-heat area (33) into the feed channels (29 and 30).

FIG. 11 illustrates the flow of the further heated feed (11) into, in and out of the standard configuration of frames (3), (4) and (6). The further heated feed (11) is passing the frames (6) and (3) in the closed feed channel (42) and is flashing/evaporating in the open concentrate channel (41) in evaporation frame (4) to create the vapour (7) and to become the concentrate (13). The concentrate (13) leaves the evaporation frame out of the open concentrate channel (41). The vapour flows, passing the orifice (43), into the functional area (55).

Although the present disclosure has been described in the context of certain aspects and embodiments, it will be understood by those skilled in the art that the present disclosure extends beyond the specific embodiments to alternative embodiments and/or uses of the disclosure and obvious implementations.

We claim:

1. A system for evaporation and condensation comprising:
at least one evaporation-condensation unit comprising a plurality of frames arranged in a series of stacks, wherein each stack comprises:
at least one evaporation frame (4);
at least one preheating frame (6); and
at least one condensation frame (3), and a polymeric sheet (8) separating each frame from the other;
wherein each frame comprises a top support, a functional area, and a plurality of channels and orifices for enabling the flow of fluid in multiple forms;
wherein each frame is made of a polymer material and the plurality of frames are detachably integrated within the evaporation-condensation unit (2), the plurality of frames are alternatively arranged within the evaporation-condensation unit.

2. The system as claimed in claim 1, wherein the plurality of frames are arranged in the stack configuration of [(3, 6, 3, 4)+(3, 6, 3, 4) . . . ].

3. The system as claimed in claim 1, wherein the plurality of frames are arranged in the stack configuration of [(3, 6, 3, 4, 3, 6, 3, 6)+(3, 6, 3, 4, 3, 6, 3, 6) . . . ].

4. The system as claimed in claim 1, wherein the frames may be arranged in the stack configuration of [(3, 6, 3, 4, 4)+(3, 6, 3, 4, 4) . . . ].

5. A system for evaporation and condensation comprising:
at least one evaporation-condensation unit comprising a plurality of frames arranged in a series of stacks, wherein each stack comprises:
at least one evaporation frame (4) comprising a bottom flash chamber (41) with an orifice (19) opening into a functional area (56), two closed feed channels (29, 30) on either side of the bottom flash chamber (41), two top vapour channels (15, 16) with respective orifices (17, 18) opening in to the functional area (56);
at least one preheating frame (6) comprising two feed channels (29, 30) with orifices (31, 32) opening into a functional pre-heating chamber (33) on either side of a bottom closed feed channel (42), a top feed channel (34) with an orifice (35) opening into the functional pre-heating chamber (33);
at least one condensation frame (3) comprising a bottom closed feed channel (42) with two closed feed channels (29, 30) on either side, two top vapour channels (19, 20) with respective orifices (21, 22) opening into a functional condensation area (23), two distillate channels (26, 27) with orifices (24, 25) on either side of the bottom closed feed channels (29, 30) opening into the functional condensation area (23); and
a polymeric sheet (8) separating the evaporation frame (4), condensation frame (3) and the pre-heating frame (6) from each other.

6. The system as claimed in claim 1, wherein the system further comprises at least one heat exchanger coupled with the at least one evaporation-condensation unit and configured to receive the feed (10) from the preheating frame (6).

7. The system as claimed in claim 1, wherein the series of stacks are arranged in a repeated pattern.

8. The system as claimed in claim 1, wherein the series of stacks are arranged in an alternative pattern.

9. The system as claimed in claim 1, wherein the polymeric sheet is made of materials selected from Polypropylene (PP), Polyvinyl chloride (PVC) or Polyvinylidene fluoride (PVDF).

10. The system as claimed in claim 1, wherein thickness of polymeric sheet is in the range of 10 μm to 40 μm.

11. The system as claimed in claim 1, wherein each stack further comprises at least two evaporation frames (4) placed side by side along with alternate placement of condensation frames (3) and preheating frames (6).

12. The system as claimed in claim 1, wherein at least two evaporation-condensation units are arranged in series forming a multistage system for evaporation and condensation.

13. The system as claimed in claim 1, wherein at least two evaporation-condensation units are integrally mounted in series within a sealed unit forming a multistage system for evaporation and condensation.

14. A method for evaporation and condensation, the method comprising:
passing a feed (10) through at least one evaporation-condensation unit (2) at a first inlet A, wherein the at least one evaporation-condensation unit comprises a plurality of frames arranged in a series of stacks, each stack comprises at least one evaporation frame (4), at least one preheating frame (6) and at least one condensation frame (3); and a polymeric sheet (8) separating each frame from other;
distributing the feed to the at least one preheating frame (6) of the at least one evaporation-condensation unit (2);
preheating the feed (10) in the at least one preheating frame (6) and passing the preheated feed to at least one heat exchanger coupled with the at least one evaporation-condensation unit at a first outlet B;
heating the feed further to a higher temperature in the at least one heat exchanger (12) to form a further heated feed (11);
feeding back the further heated feed (11) to the at least one evaporation-condensation unit (2) at a second inlet E,
flashing the further heated feed (11) in the at least one evaporation frame (4) to a lower temperature and temperature according to the thermodynamic conditions to form a vapour (7);
passing the vapor (7) to at least one condensation frame (3) separated by the polymer sheet (6) from the least one evaporation frame (6) and the least one preheating frame (4);
forming a distillate (5) and a concentrate (13) by condensing the vapor (7) at the at least one condensation frame (3) and
collecting the distillate (5) from the evaporation-condensation unit (2) at a distillate outlet (H) and the concentrate (13) from the evaporation-condensation unit (2) at a concentrate outlet (G);
wherein each frame is made of a polymer material and the plurality of frames are detachably integrated within the evaporation-condensation unit (2), the plurality of frames are alternatively arranged within the evaporation-condensation unit.

15. The method as claimed in claim 14, wherein the method further comprises of heating the feed (10) by the vapor (7) condensing on an outer surface of the polymeric sheet of at least one preheating frame.
